(19) United States
(12) Patent Application Publication
(10) Pub. No.: US 2005/0048991 A1
(43) Pub. Date: Mar. 3, 2005

(54) Method and apparatus for addressing short messages to mobile devices that do not have valid telephone numbers

(75) Inventor: Matthew Hertz, Hod Hasharon (IL)

Correspondence Address: DR. MARK FRIEDMAN LTD.;c/o Bill Pokinghorn, Discovery Dispatch, 9003 Florin Way, Upper Marlboro, MD, 20772, US

(73) Assignee: OMBEK LTD

(21) Appl. No.: 10/652,247

(22) Filed: Sep. 2, 2003

(51) Int. Cl. H04Q 7/20

(52) U.S. Cl. 455/466; 455/414.1

(57) ABSTRACT

A method and system for routing messages addressed to mobile devices that do not have a valid telephone number. The method includes receiving a message addressed to a recipient address having two sections: a first section with a two-part prefix comprising a mobile identification number (MIN) identifier and a network identifier, and a second section comprising a MIN; identifying from the first section that the second section is a MIN belonging to a destination network; stripping the two-part prefix from the address; and sending the message to the mobile device using the original MIN. The prefix is preferably of type AAABBB, where AAA is the MIN identifier and BBB is the network identifier. The system includes a message routing function operative to perform identification of the mobile device from the recipient address.

### FIELD OF THE INVENTION

The present invention relates to methods for delivering text messages across wireless networks to mobile devices such as cellular telephones and pagers, and, more particularly, to methods for addressing text messages to mobile devices that do not have valid telephone numbers.

### BACKGROUND OF THE INVENTION

Mobile text messages such as paging, short messaging service (SMS) messages and the like, all referred to herein as “SMS” messages, are text messages sent from or to mobile devices such as mobile phones pagers, personal digital assistance (PDA) devices, etc. SMS is a major source of revenue for wireless operators, and the fastest growing service in the wireless industry. Worldwide, more than one billion SMS messages are sent daily, generating significant revenues for operators.

Systems that transmit messages between wireless devices or networks are known. Such a system is generally referred to as Short Messaging Service Center (SMSC) or SMSC-Gateway and provided by companies such as LogicaCMG (Stephenson House, 75 Hampstead Road London, NW1 2PL, UK). Such a system receives a message from an originating device or system, and, using a routing table, locates the intended recipient device and transmits the message to that device. If the recipient device is on a different network (i.e. if the recipient telephone number does not appear in the SMSC internal routing table), the system will transfer the message to a “gateway” such as the SMSC-Gateway provided by LogicaCMG above. A gateway is a system that transmits messages between different SMSCs. In addition to converting SMS messages between different formats, a gateway uses a routing table linking telephone numbers or number-ranges with their corresponding networks/SN/ISCs. The gateway receives the message, determines the recipient's network, and then converts, reformats and sends the message to the appropriate recipient's network in the correct format.

The routing and addressing module in existing SMSCs is based on the subscriber's MDN (Mobile Directory Number) or the subscriber's MIN (Mobile Identification Number). The MDN is the telephone number used when calling the mobile device, and the MIN is the internal identification number of the mobile device in a cellular network. In paging networks, an MIN is usually referred to as a PIN (Personal Identification Number). Being an internal identification numbers, a MIN does not adhere to the telephone numbering system rules, and is not unique outside its network. Thus, an MIN cannot be used in an addressing and routing system outside its network. Some mobile devices have a valid associated MDN for addressing voice-calls and text-messages. However, many mobile devices have only a MIN, making it impossible to route inter-network messages addressed to them.

A valid telephone number is typically constructed from (i.e. comprises) an area code, a telephone exchange code and a subscriber code. For example, in North America, telephone numbers are in the form NPA-NXX-XXXX, where NPA (Numbering Plan Area) is the term used for area code, NXX is the telephone exchange code, and XXXX stands for the 4 digits subscriber number. The operating network of any telephone number can be determined by looking-up a table of NPA, NXX and XXXX ranges. Such a table is shown in FIG. 5.

FIG. 1 shows a typical computer-based SMSC-Gateway system 100, comprising a message receive function 102, a route function 104, a numbering database 108 and a transmit function 106. When a new message arrives in system 100, message receive function 102 accepts the message details (sender, recipient, content etc.) and transfers them to route function 104. Route function 104 searches numbering database 108 for the network of the recipient telephone number. If a network is found, function 104 sends the message using transmit function 106. If a network is not found, function 104 sends an error message to the sender using transmit function 106.

The steps in method of handling of a message in system 100 are additionally described in FIG. 2. The system receives in step 202 a message with the sender and recipient addresses. In step 204, the system (through route function 104 above) searches for the recipient network in a routing table, such as table 500 in FIG. 5 below. If the recipient network is found, the message is sent in step 208. If the network is not found, an error message is sent to the sender in step 210.

In a typical system, numbering database 108 includes a universal routing table such as table 500, FIG. 5, where each number is universally unique and assigned to a network; no two similar numbers can appear in this table, since a conflict is created if the table is pointing one number to two (or more) different networks. Accordingly, in the typical system, message routing function 104 either rejects messages addressed to non-valid telephone numbers (MINs) due to an unrecognized format (wrong number of digits) or, if the format is recognized (number of digits is similar to a telephone number), addresses each such message erroneously to a telephone number (MDN) similar to the MIN.

Methods for routing involving multiple SMSCs are known, and described for example in U.S. Pat. No. 6,292,669 to Meuronen, et al., and in U.S. Pat. No. 6,208,870 to Lorello et al. which are incorporated herein by reference. Such methods attend only to cases where a recipient address is a universally unique number, such as a telephone number, so that a universal routing table can be established. In these cases, searching through the table provides a clear means for routing each number to the recipient network. However, in cases where the recipient address is a MIN, which is not a universally unique number, this universal routing table cannot be used, as it creates a conflict if a similar number already appears in the table and is pointing to a different network.

There is therefore a need for, and it would be advantageous to have, a method and system for addressing short messages to mobile devices that do not have universally valid telephone numbers.

### SUMMARY OF THE INVENTION

The present invention provides a system and method for addressing short messages to mobile devices without valid (or “non-valid”) telephone numbers (i.e. mobile devices having a MIN). According to the present invention every network is assigned a prefix, very similar to an area code, which users will then dial before the MIN.

According to the present invention there is provided a method for addressing a message sent by a sender to a mobile device that does not have a valid telephone number, the method comprising the steps of receiving a prefixed MIN address that includes a two-part prefix attached to a non unique, intra-network mobile identification number, the prefixed MIN address uniquely defining the mobile device, and routing the message to the mobile device using the prefixed MIN address.

According to one feature in the method for addressing a message sent by a sender to a mobile device that does not have a valid telephone number, the two-part prefix includes as a first part a MIN identifier, and as a second part a network identifier.

According to another feature in the method for addressing a message sent by a sender to a mobile device that does not have a valid telephone number, the step of routing includes searching a database for a destination network identified by the network identifier, and removing the prefix from the prefixed MIN address, thereby leaving a recipient address comprising only the MIN.

According to the present invention there is provided a method for routing a message having a recipient address to a mobile device that does not have a valid telephone number, the method comprising the steps of checking the recipient address, and based on the checking, uniquely identifying the recipient address with the mobile device.

According to one feature in the method for routing a message having a recipient address to a mobile device that does not have a valid telephone number, the recipient address includes a two-part prefix comprising a MIN identifier and a network identifier, the address further comprising a MIN.

According to another feature in the method for routing a message having a recipient address to a mobile device that does not have a valid telephone number, the identifying further includes identifying a destination network from the network identifier.

According to the present invention the method for routing a message having a recipient address to a mobile device that does not have a valid telephone number further comprises removing the prefix and sending the message to the mobile device identified by the MIN on the destination network.

According to the present invention there is provided a system for routing SMS messages to mobile devices that do not have valid telephone numbers comprising: a receive message function operative to receive a message having a recipient address that includes a prefix attached to a second section of a number; a routing message function operative to identify a recipient based on the recipient address, the routing function further operative to remove the prefix; and a send message function for sending the message to the mobile device.

According to one feature in the system for routing SMS messages to mobile devices that do not have valid telephone numbers according to the present invention, the prefix includes a MIN identifier that indicates that the second section of the number is a MIN, the prefix further including a network identifier identifying a destination network of the mobile device.

According to the present invention there is provided a system for routing SMS messages to mobile devices comprising; a receive message function operative to receive a message having a recipient address; a routing message function operative to decide, based on the recipient address, if the recipient address has a valid or non-valid telephone number; and means to send the message to the recipient address.

According to one feature in the system for routing SMS messages to mobile devices according to the present invention, the recipient address is a number comprising a prefix+second section, the prefix indicating that the recipient address is a non-valid telephone number.

According to another feature in the system for routing SMS messages to mobile devices according to the present invention, the prefix includes as a first part a MIN identifier that identifies the second section as a MIN, and as a second part a network identifier that identifies a destination network associated with the MIN, the network identifier stored in a network identifiers database.

According to yet another feature in the system for routing SMS messages to mobile devices according to the present invention, the routing function is further operative to remove the prefix and leave the second section as an address identifying the mobile device.

### BRIEF DESCRIPTION OF THE DRAWINGS

The invention is herein described, by way of example only, with reference to the accompanying drawings. In the drawings, like reference numbers indicate identical or functionally similar elements.

FIG. 1 shows a basic configuration of an existing message transmission system;

FIG. 2 is a flowchart showing the process of the message routing function in the system of FIG. 1;

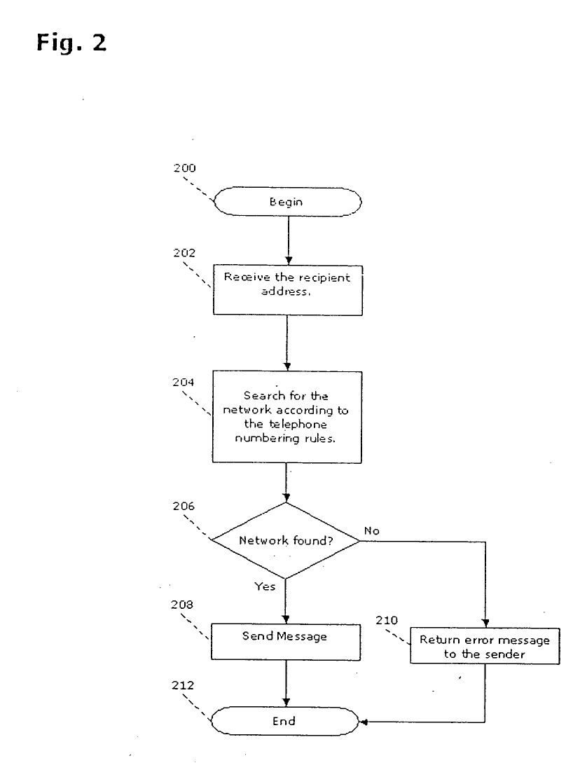

FIG. 3 shows a basic configuration of a message transmission system according to the present invention;

FIG. 4 is a flowchart showing the process of the message routing function according to the present invention;

FIG. 5 shows an exemplary table in a routing database of valid telephone numbers;

FIG. 6 shows an exemplary table in a routing database of network identifiers (BBB) for non-valid telephone numbers according to the present invention.

### DETAILED DESCRIPTION OF THE PREFERRED EMBODIMENTS

The present invention provides a system and method for addressing short messages to mobile devices without valid telephone numbers, whereby every network is assigned a two-part prefix, very similar to an area code, which users will then dial before the (PIN) MIN. The system recognizes the prefix, and routes the message using a special “prefix table”; after identification of the recipient network, the prefix is removed from the MIN, and the message is transmitted with the original MIN to the identified network.

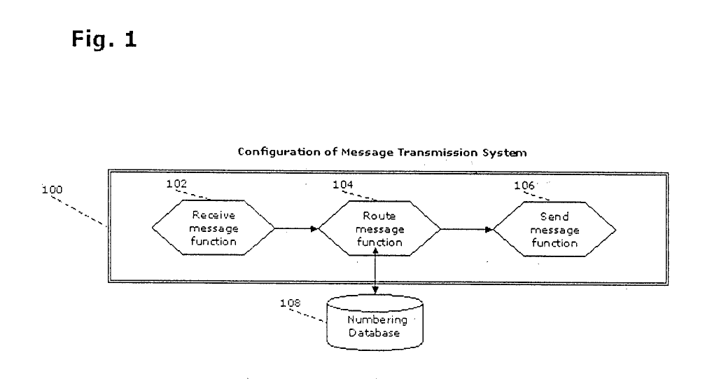

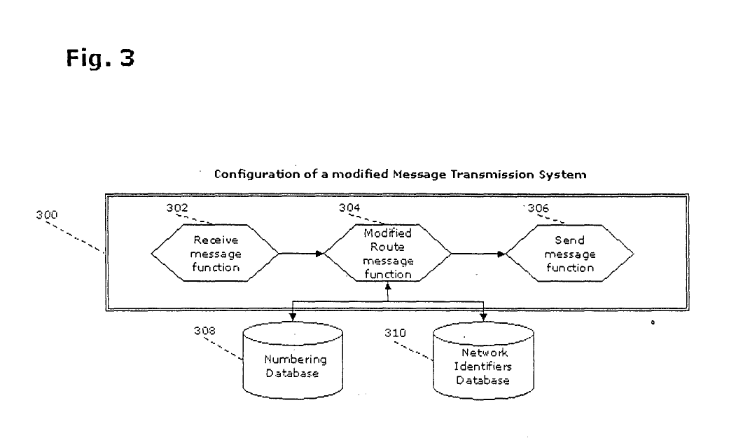

FIG. 3 shows a modified SMSC-Gateway system 300 according to the present invention. System 300 differs from prior art systems such as system 100 of FIG. 1 in that it comprises a modified route message function 304 (instead of function 104) and an added network identifiers database 310. When a new message arrives in system 300, message receive function 302 accepts the message details (sender, recipient, content, etc.) and transfers them to modified route function 304. Modified route function 304 first checks if a recipient address in the message is a valid telephone number, which is searched the accepted way in a numbering database 308, or whether the recipient address is a MIN (i.e. “non-valid telephone number”) as part of a prefix+MIN number. If the latter, the prefix is searched in network identifiers database 310, after which the prefix is removed from the address. A prefix+MIN number in the present invention is also referred to as a “prefixed MIN address”. Either way, whether the recipient address is a valid telephone number or a prefixed MIN address, if a network is found, modified route message function 304 sends the message using transmit function 306, and if the network is not found, function 304 sends an error message to the sender using transmit function 306. A prefix in the system and method of the present invention may be any number, of any predetermined length. However, in order to simplify the description, the example given below uses a 6 digits number. The first three digits (first part) in the prefix, referred to as “MIN identifier” or AAA, are used to determine that the recipient address is not a valid telephone number, and thus must be routed differently than a valid telephone number. The next three digits (i.e. second part), referred to as the “network identifier” or BBB, are used to determine the network to which the MIN belongs.

As a MIN identifier, the AAA by its nature cannot be similar to any prefix of a valid telephone number such as country code or an area code. Therefore, it must be a number that according to the International Telecommunication Union (ITU) recommendation E.164, which is incorporated herein by reference, cannot be and cannot begin with a country-code of a valid telephone number, and according to the NANPA (North America Number Plan Authority) cannot be a valid area code. Examples for admissible AAA numbers include 211 and 999, but any number that fulfills the conditions above will be acceptable. The network identifier BBB in this example is a 3-digit code that is assigned to each network using MINs. For example, a network A will be assigned a network identifier 200, a network B will be assigned a network identifier 201, and so on. Thus, in order to send a message to a subscriber with a 12345 MIN on network A, a sender will address the message to the number 100 200 12345 (AAA BBB MIN).

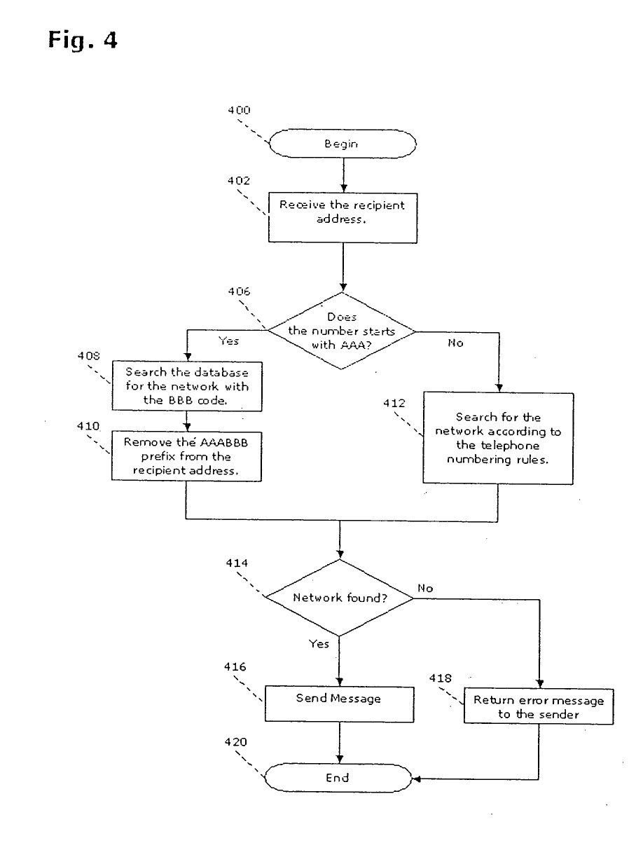

In use, in contrast with methods used in prior art systems, a message routed by routing message function 304 undergoes the additional steps of determining weather the recipient address is a valid telephone number or a prefixed MIN address, prior to searching the applicable routing database (308 or 310), and prior to undergoing a treatment to remove the prefix from the original address if the address was a prefixed MIN address. The additional steps and the treatment of a prefixed MIN address to remove the prefix, which embody the essential features of the method of the present invention, and which involve exchange of information with databases, is performed by the modified routing software 304, as described in further detail in FIG. 4.

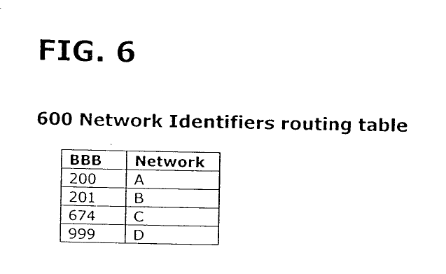

FIG. 4 describes a method of routing messages using a modified SMSC-Gateway system 300 according to the present invention. The system receives in step 402 a message with the sender and the recipient addresses. In step 406, the recipient address is analyzed to check if the address starts with AAA. If it does (“Yes”—the first 3 digits are the predefined MIN identifier), i.e. if this is a prefixed MIN address, the system, in step 408, searches for the recipient network in a network identifier table containing network identifiers BBB, as shown for example in a table 600 in FIG. 6. Then, in step 410, the system removes the two-part AAABBB prefix from the original prefixed MIN address, so that the recipient network will only get the original MIN digits (e.g. 12345), and will be able to recognize the recipient. Steps 408-410 reflect the special treatment or the essence of “addressing short messages to mobile devices without valid telephone numbers” mentioned above.

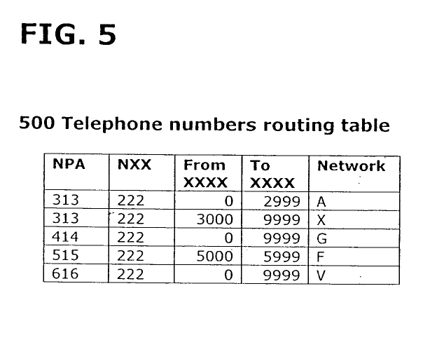

Returning to step 406, if the recipient address is analyzed and the address is found not to start with AAA (“No”), the system assumes it is a valid telephone number, and handles it accordingly, i.e. in step 412 the system searches for the recipient network within a telephone numbers routing table such as table 500 of FIG. 5. In either case (either “Yes” or “No” in step 406), i.e. whether the recipient address is a MIN or a valid telephone number, i the network is searched for in step 414, and, if found, the message is sent to the network in step 416. If the network is not found in step 414, an error message is sent to the sender in step 418.

An exemplary database system that may be used either for database 308 or database 310 (or both) is an RDBMS (Relational DataBase Management System). An example to an RDBMS is Oracle database (Oracle Corp., Redwood Shores, Calif.). Computer systems incorporating RDBMS software using a Structured Query Language (SQL) interface are well known in the art.

In summary, the present invention provides an advantageous solution to the problem of messages addressed to mobile devices that do not have a valid telephone number. This is done by providing as an address a prefix+MIN number (also referred to as “prefix plus second section”), in which the prefix is preferably of type AAABBB, where AAA is a MIN identifier and BBB is a network identifier. The system recognizes from the AAA MIN identifier that the recipient address is a MIN, and from the BBB network identifier the network to which this MIN belongs. The system then removes the AAABBB prefix before sending the message to the recipient network. Note that the three-digit embodiment of both the MIN identifier (AAA) and network identifier (BBB) is exemplary only. As mentioned, the prefix can be of any arbitrary length, and other embodiments using a different number of digits are possible and in the scope of the present invention.

The system described above can be implemented in software or hardware, or a combination of software and hardware. When implemented primarily in hardware, it may use components such as Programmable Array Logic units (PALs), application specific integrated circuits (ASICs), or other hardware components. Implementation of a hardware state machine to perform the functions described herein will be apparent to persons skilled in the relevant arts.

All publications mentioned in this specification are herein incorporated in their entirety by reference into the specification, to the same extent as if each individual publication was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made. What has been described above is merely illustrative of the application of the principles of the present invention. Those skilled in the art can implement other arrangements and methods without departing from the spirit and scope of the present invention. The method of the invention can be implemented in software, which can be stored on computer disks or other computer-readable media, for execution in a host or target computer.

1. A method for addressing a message sent by a sender to a mobile device that does not have a valid telephone number, the method comprising the steps of:
a. receiving a prefixed MIN address that includes a two-part prefix attached to a non unique, intra-network mobile identification number, said prefixed MIN uniquely defining the mobile device; and
b. routing the message to the mobile device using said prefixed MIN address.

2. The method of claim 1, wherein said two-part prefix includes as a first part a MIN identifier and as a second part a network identifier.

3. The method of claim 2, wherein each of said MIN identifier and said network identifier has three digits.

4. The method of claim 1, wherein said step of routing includes searching a database for a destination network identified by said network identifier, and removing said prefix from said prefixed MIN address, thereby leaving a recipient address comprising only said MIN.

5. The method of claim 4, wherein, if said destination network is found, said step of routing further includes sending said message to said MIN on said destination network.

6. The method of claim 4, wherein, if said destination network is not found, said step of routing further includes generating an error message sent back to the sender.

7. A method for routing a message having a recipient address to a mobile device that does not have a valid telephone number, the method comprising the steps of:
a. checking the recipient address; and
b. based on said checking, uniquely identifying said recipient address with the mobile device.

8. The method of claim 7, wherein said recipient address includes a two-part prefix comprising a mobile identification number (MIN) identifier and a network identifier, said recipient address further including a MIN.

9. The method of claim 8, wherein said identifying further includes identifying a destination network from said network identifier.

10. The method of claim 9, further comprising removing said two-part prefix and sending said message to the mobile device identified by said MIN on said destination network.

11. A system for routing SMS messages to mobile devices that do not have valid telephone numbers comprising:
a. a receive message function operative to receive a message having a recipient address that includes a prefix attached to a second section of a number;
b. a routing message function operative to identify the mobile device based on said recipient address, said routing function further operative to remove said prefix; and
c. a send message function for sending said message to the mobile device.

12. The system of claim 11, wherein said prefix includes a MIN identifier that indicates that said second section is a MIN, said prefix further including a network identifier identifying the destination network of the mobile device.

13. The system of claim 12, wherein said MIN identifier and said network identifier include each three digits.

14. The system of claim 12, wherein said network identifier is included in a network identifiers database, said routing message function communicating with said network identifiers database in said operation to identify said destination network.

15. The system of claim 14, wherein said prefix is stripped by said routing function, leaving said MIN, and wherein said send message function is used to send the message to said MIN on said destination network.

16. A system for routing SMS messages to mobile devices comprising;
a. a receive message function operative to receive a message having a recipient address;
b. a routing message function operative to decide, based on said recipient address, if said recipient address has a valid or non-valid telephone number; and
c. means to send said message to said recipient address.

17. The system of claim 16, wherein said recipient address is a valid telephone number, and wherein said means include means to route valid telephone numbers.

18. The system of claim 16, wherein said recipient address is a number comprising a prefix+second section, said prefix indicating that said recipient address is a non-valid telephone number.

19. The system of claim 17, wherein said prefix includes as a first part a mobile identification number (MIN) identifier that identifies said second section as a MIN, and as a second part a network identifier that identifies a destination network associated with said MIN, said network identifier stored in a network identifiers database.

20. The system of claim 18, wherein said routing function is further operative to remove said prefix and leave said second section as an address identifying the mobile device.
